(19) United States
(12) Patent Application Publication
(10) Pub. No.: US 2026/0264233 A1
(43) Pub. Date: Sep. 10, 2026

(54) EDIT DISTANCE BASED TASK-INTENTION ESTIMATION FOR TELEOPERATED ASSEMBLY TASK

(71) Applicant: Honda Motor Co., Ltd., Tokyo (JP)

(72) Inventors: Aolin XU, Santa Clara, CA (US); Songpo LI, San Jose, CA (US); Prakash BASKARAN, San Jose, CA (US); Soshi IBA, Mountain View, CA (US); Behzad DARIUSH, San Ramon, CA (US)

(73) Assignee: Honda Motor Co., Ltd., Tokyo (JP)

(21) Appl. No.: 19/198,354

(22) Filed: May 5, 2025

Related U.S. Application Data
(60) Provisional application No. 63/767,664, filed on Mar. 6, 2025.

(51) Int. Cl. B25J 9/16

(52) U.S. Cl. CPC B25J 9/163; B25J 9/1661; B25J 9/1689

(57) ABSTRACT

A method for intention estimation in robot teleoperation task is provided. The method may compute a correlation between an observed action sequence and nominal action sequences that define viable tasks sequentially using edit distance.

### RELATED APPLICATIONS

This patent application is related to U.S. Provisional Application No. 63/767,664 filed Mar. 6, 2025, entitled “EDIT DISTANCE BASED TASK-INTENTION ESTIMATION FOR TELEOPERATED ASSEMBLY TASKS”, in the names of the same inventors and which is incorporated herein by reference in its entirety. The present patent application claims the benefit under 35 U.S.C § 119(e) of the aforementioned provisional application.

### BACKGROUND

Human-robot collaboration has gained significant attention in recent years, particularly in teleoperated assembly tasks, where a human operator may remotely control a robot to perform complex assembly procedures. One challenge in such tasks may be intention estimation. Intention estimation may involve determining both the operator's intended task and predicting subsequent actions. Accurately estimating intention may be important for improving the efficiency and autonomy of teleoperated robotic systems.

Traditional intention estimation methods may rely on predefined models or machine learning techniques trained on extensive datasets. However, these approaches may struggle when faced with large deviations from expected action sequences. Such deviations may arise due to: (1) Operator variability—Human operators, especially novices, may not follow predefined action sequences strictly, which may lead to inconsistent execution patterns; and (2) Action recognition errors—Action recognition models trained on one set of tasks may not generalize well to new tasks, which may result in a high rate of misclassifications. In addition, the operator variability may exacerbate action recognition errors, even working with the same set of tasks.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a method for intention estimation in a robot teleoperation task is provided. The method may compute a correlation between an observed action sequence and nominal action sequences that define viable tasks sequentially using edit distance.

According to an embodiment of the disclosure, a method for intention estimation in a robot teleoperation task is provided. The method may compute a correlation between an observed action sequence and nominal action sequences that define viable tasks sequentially using edit distance which uses a nearest neighbor rule for task estimation and action prediction. The method may construct a task distance matrix where each entry in the task distance matrix represents edit distances between elements of the observed action sequence and a current nominal action sequence of the nominal action sequences to analyze task similarities and confusion points showing when and where estimation errors are to occur.

According to an embodiment of the disclosure, a method for intention estimation in a robot teleoperation task is provided. The method may compute a correlation between observed action sequences and nominal action sequences that define viable tasks sequentially using edit distance. The method may construct a first task distance matrix where each entry in the first task distance matrix represents edit distances between elements of a first observed action sequence and a first nominal action sequence to analyze task similarities and confusion points showing when and where estimation errors are to occur. The method may compute the edit distances between the elements of the first observed action sequence and the elements of the first nominal action sequence using an optimization process.

### BRIEF DESCRIPTION OF THE DRAWINGS

FIGS. 1A-1D depict an exemplary teleoperated assembly task for edit distance based task-intention estimation in accordance with an embodiment of the disclosure;

FIGS. 2A-2F depict exemplary toy assembly tasks used for a training action recognition module in accordance with an embodiment of the disclosure;

FIG. 3 depicts an exemplary chart showing inferred actions against to action ground truth in accordance with an embodiment of the disclosure;

FIG. 4A-4C depicts an exemplary toy assembly tasks where a pretrained action recognition module is deployed upon in accordance with an embodiment of the disclosure;

FIG. 5 depicts an exemplary diagram depicting a nearest neighbor rule for task estimation in accordance with an embodiment of the disclosure;

FIGS. 6A-6C show exemplary charts depicting average task estimation error rate without the presence of errors in observed action sequence where the x-axis are the action time indices, each indicates the number of observed actions when the task estimation is performed in accordance with an embodiment of the disclosure;

FIGS. 7A-7C show exemplary charts depicting average task estimation error rate with different amount of errors in observed action sequence where the x-axis are the action time indices, each indicates the number of observed actions when the task estimation is performed in accordance with an embodiment of the disclosure;

FIGS. 8A-8C show exemplary charts depicting average action prediction error rate without the presence of errors in observed action sequence where the x-axis are the action time indices, each indicates the action being predicted in accordance with an embodiment of the disclosure;

FIGS. 9A-9C show exemplary charts depicting average action prediction error rates with different amount of errors in observed action sequence where the x-axis are the action time indices, each indicates the action being predicted in accordance with an embodiment of the disclosure;

FIGS. 10A-1-10C-2 show exemplary charts depicting task estimation error rates of each task with different amount of errors in observed action sequence where the x-axis are the time indices of actions, indicating the number of observed actions used in each estimation in accordance with an embodiment of the disclosure; and

FIGS. 11A-1-11C-2 show exemplary charts depicting action prediction error rates of each task with different amount of errors in observed action sequence where the x-axis are the time indices of actions being predicted in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Reference will now be made in detail to specific aspects or features, examples of which are illustrated in the accompanying drawings. Wherever possible, corresponding, or similar reference numbers will be used throughout the drawings to refer to the same or corresponding parts.

The present system and method tackle the problem of intention estimation in human-robot teleoperation, which may include identifying the task being executed and predicting the next actions. To address these challenges, the present system and method proposes an edit distance-based intention estimation method for teleoperated assembly tasks. This approach may quantify the similarity between the observed action sequence and predefined nominal action sequences using edit distance, a metric which may be widely used in sequence comparison. By leveraging the nearest neighbor rule, the method may identify the most likely intended task and may predict future actions based on the closest matching sequence.

One advantage of the present approach may lie in its robustness to significant deviations in observed action sequences. Unlike previous methods that may rely on exact action matches or rigid probabilistic models, the present edit distance-based framework may accommodate variations in operator behavior and recognition errors while maintaining accurate intention estimation.

The present system and method has been validated through both simulations and real-world experiments, which may demonstrate its effectiveness in diverse teleoperated assembly scenarios. The results may confirm that the present approach may outperform conventional techniques in handling noisy and uncertain action sequences, making it a promising solution for improving human-robot collaboration in teleoperated assembly tasks.

Levenshtein distance, which may also be known as edit distance, may be a metric used to quantify the similarity between two strings. It may compute the minimum number of edits to transform one string to another in terms of insertion, deletion, and substitution. This measure may provide valuable insights into string similarity, which may form a tool in natural language processing, computational biology, and autocorrection.

In the domain of robotics and action recognition, Levenshtein distance may be used as a similarity metric in comparing action or gesture sequences and even in recognizing the actions. For example, in one instance, individuals may decompose the human actions into smaller units called “actlets”, which may correspond to atomic movements or gestures. Then, the human actions may be encoded as a string of actlets. Based on the Levenshtein distance metric, the k-nearest neighbors of a newly observed action may be computed to determine the new action's class. The similar framework may also be used to recognize the gestures and motions in surgeries and industry by computing the Levenshtein distance between the sub-gesture sequences.

Others may have used the Levenshtein distance as an evaluation metric when comparing two actions sequences. In one example, it may have been proposed to use Vision Language Model (VLM) to do one-shot demonstration for the robot to operate. The symbolic task plan generated from the VLM may be compared to the correct task sequences to evaluate the generated plans' quality. In another example, a fine-grained action segmentation algorithm may have been developed to target applications of human-robot interaction, video surveillance, and human skill evaluation. In their performance evaluation, a segmental metric based on the Levenshtein distance may have been adopted, which may focus on the ordering of actions but not the specific timings as different annotators might have different interpretations of when an action started and ended. In other examples, Levenshtein distances may have been employed as a metric for evaluating the refining action recognition algorithms within the context of action segmentation.

In a learning setting, each individual's action sequence may be compared to the action sequence which had the best performance using Levelshetein distance to evaluate whether individuals may apply what they have learned about technology and engineering skills to real-life situations.

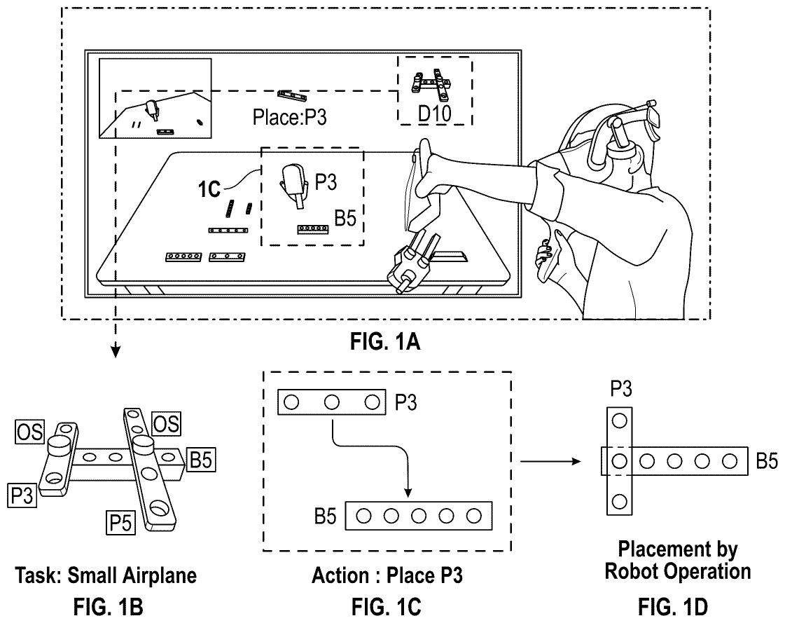

In the present system and method, one may consider the teleoperation for assembly tasks. There may be different tasks to be completed by a robot that may be teleoperated by an operator. Each task may be completed by taking a sequence of actions, and each action may involve acting in a certain way on an object. Though not required, the action sequences may be specified by an instruction manual, where one or multiple nominal action sequences may be assigned to each task. For example, as may be shown in FIGS. 1A-1D, a user may be trying to perform a human-robot teleoperation assembly task (FIG. 1A). The task may be to assemble a toy airplane as may be shown in FIG. 1B. FIGS. 1C-1D may show the first two actions which may be taking and placing object B5 and then taking the object P3 and place it on top of B5, such that its middle hole is aligned with the object B5's left or right end, and the two objects form a cross-like shape.

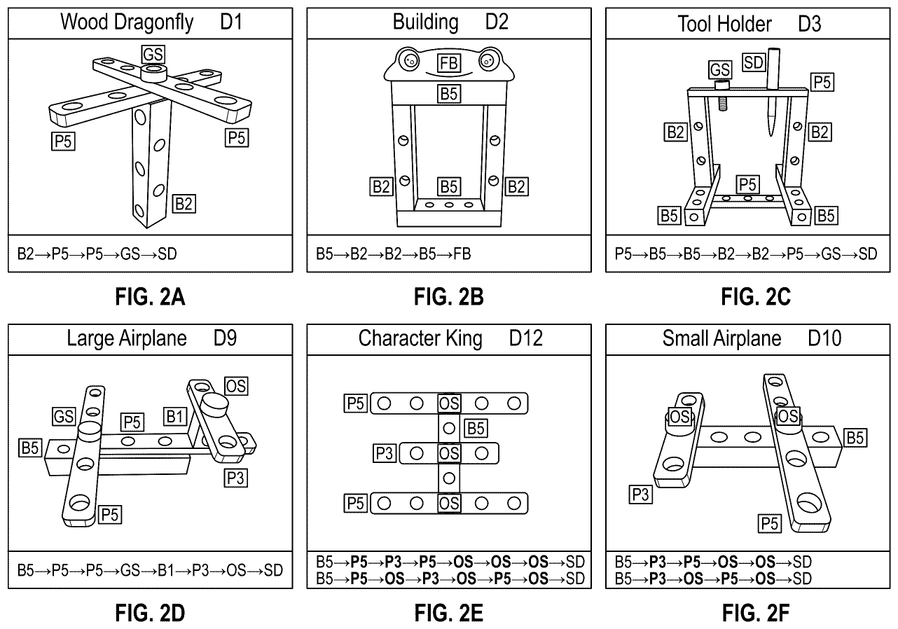

Referring to FIGS. 2A-2F, a set of toy assembly tasks may be shown which one may experiment on. These tasks may be used for the training of an action recognition model. The nominal action sequences of the tasks may also be shown in each picture.

As an operator is taking actions to complete a task, the goal of intention estimation may include estimating the task being completed and predicting the next action, both may be based on the observed actions taken by the operator so far. Timely and accurately estimating the task and the operator's action may be important for the teleoperating system to determine what the robot operation needs to be carried out at each step to complete each action and finally the task.

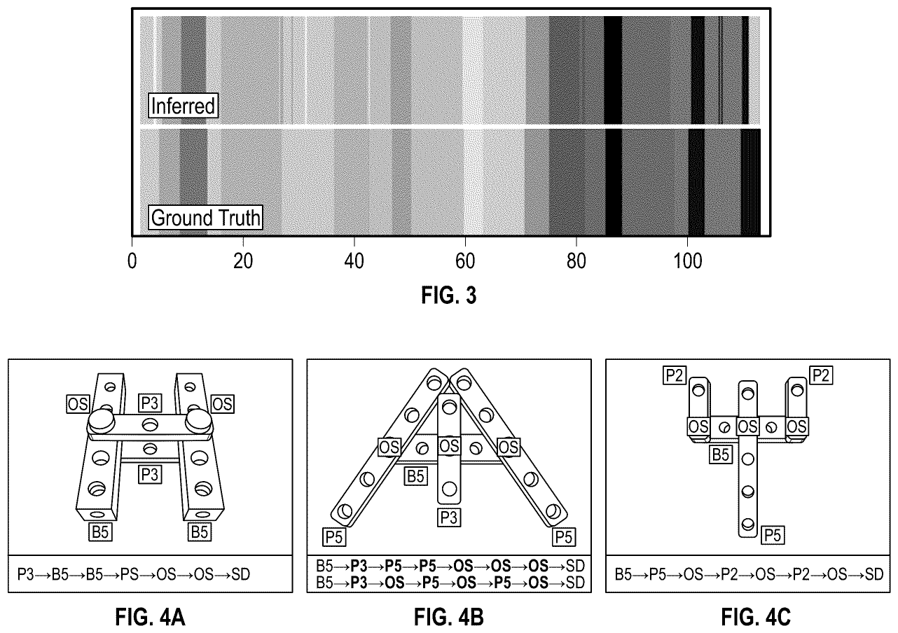

The proposed action recognition module to be used may be pretrained on the different assembly tasks shown in FIGS. 2A-2F. Action recognition errors may occur during the transition of the actions, which may be illustrated in FIG. 3. FIG. 3 may show the inferred actions against to the action ground truth with colors. It can be seen that the recognized actions vary frequently, indicating recognition errors, during the action transitions.

One may propose a discrete-time action extraction module to mitigate such action recognition errors, and it may achieve accuracy as high as 91% to 97% on the tasks where the action recognition module is trained on and when the operator strictly follows the instruction manual, and also at the expense of additional delay in the intention estimation.

With experimentation, one may find that the same action recognition module, when deployed to the new tasks not seen before such as those shown in FIGS. 4A-4C, its action recognition accuracy can drop considerably. This drop in accuracy may be exacerbated further by the variability of the operators, e.g. by novices who may struggle to complete some actions, or by operators who do not strictly follow the instruction manual of the assembly tasks.

These issues may pose new challenges in action recognition and intention estimation in teleoperation. One may aim to reuse the action recognition module and explore the room for intention estimation methods that may be robust to action recognition errors.

Edit distance, also known as Levenshtein distance, may be a widely used metric for measuring the dissimilarity between two sequences. It may quantify the minimum number of operations required to transform one sequence into another, where the allowed operations typically include insertion, deletion, and substitution of elements. Given an observed action sequence A=(a₁, a₂, . . . , aₘ) and a nominal action sequence B=(b₁, b₂, . . . , bₙ), the edit distance d(A,B) may serve as a measure of how closely the observed sequence aligns with the expected action sequence.

The standard approach to computing edit distance between sequences A and B may utilize dynamic programming. One may define a distance matrix D of size (m+1)×(n+1), where each entry D(i, j) may represent the edit distance between the first i elements of A and the first j elements of B. The main recursion may be given by:

$$D ( i , j ) = min \{ \begin{matrix}D ( i , j - 1 ) + 1 & ( insertion ) \\ D ( i - 1 , j ) + 1 & ( deletion ) \\ D ( i - 1 , j - 1 ) + c ( i , j ) & ( substitution )\end{matrix}$$

where c(i, j)=0 if aᵢ=bⱼ, that is, no substitution needed, and c(i, j)=1 otherwise. The upper boundaries of the matrix may simply be given by D(0, 0)=0, D(i, 0)=i and D(0, j)=j. The final edit distance d(A, B) may be found at D(m, n). Both the time and the space complexity of the computation may be O(mn).

For intention estimation, one may need to compute the edit distance between the observed action sequence A and all prefixes of each nominal action sequence B, that is, subsequences from the first element to the j-th element of B. Instead of recomputing the edit distance from scratch for each prefix, one may exploit the incremental nature of dynamic programming. By storing previously computed values in the matrix D, one may efficiently update the edit distance for each prefix Bⱼ:=(b₁, . . . , bⱼ) for j=1, . . . , n in O(mn) time.

The following steps may efficiently compute the required distances.

### Method 1: Computation of Edit Distances Between Sequence A of all Prefixes of Sequence B

| Input: Sequences A = (α₁,...,αₘ), B = (b₁,...,bₙ) | |
|---|---|
| Output: Edit distances between A and Bⱼ = (b₁,...,bⱼ) | |
| | for all j = 1,...,n |
| 1: | Initialize matrix D of size (m + 1) × (n + 1) |
| 2: | for i = 0 to m do |
| 3: | D(i, 0) ← i |
| 4: | end for |
| 5: | for j = 0 to n do |
| 6: | D(0, j) ← j |
| 7: | end for |
| 8: | for i = 1 to m do |
| 9: | for j = 1 to n do |
| 10: | c ← 1 if aᵢ ≠ bⱼ, else c ← 0 |
| 11: | D(i, j) ← min(D(i − 1, j) + 1, D(i, j − 1 + |
| | 1, D(i − 1, j − 1) + c) |
| 12: | end for |
| 13: | end for |
| 14: | return D(m, j) for all j = 1,...,n |

This method may ensure that edit distances for all prefixes of B may be computed efficiently in a single pass using the stored dynamic programming table, allowing real-time intention estimation with minimal computational overhead.

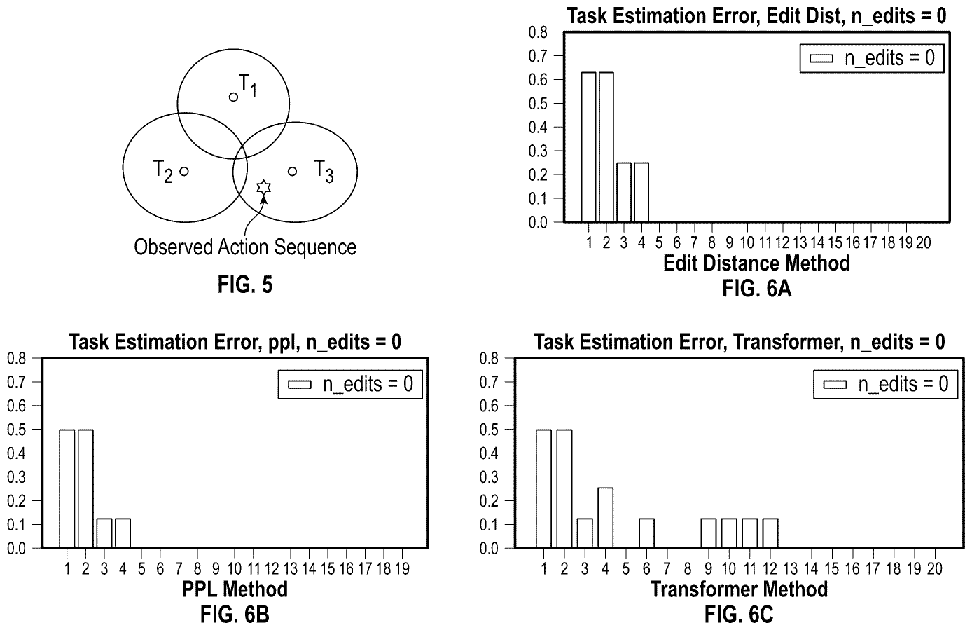

For each observed action sequence, one may compute the edit distance between the sequence and all possible prefixes of all nominal action sequences using the above method. The prefix with the smallest edit distance may provide an estimate of the task being executed as may be shown in FIG. 5. Additionally, the length of the matched prefix may serve as an estimate of the current time index within the true action sequence. This estimated time index may enable one to predict the next action by selecting the subsequent action in the identified nominal sequence. By updating this estimation sequentially as new actions are observed, the method may provide a robust and adaptive approach to real-time task estimation and action prediction in human-robot teleoperation.

Besides performing intention estimation based on the edit distance, one may gain insights on the performance of intention estimation by computing the edit distances among all nominal action sequences across all tasks at every possible time index. For example, the ith row of the following table shows the edit distance between the first i elements of the nominal action sequence of Task 3 and the nominal action sequence of all other tasks:

Example task distance matrix of Task 3 to other tasks

| Time | 0 | 1 | 2 | 3 | 4(0) | 4(1) | 5(0) | 5(1) |
|---|---|---|---|---|---|---|---|---|
| 1 | 1 | 0 | 1 | 0 | 0 | 0 | 0 | 0 |
| 2 | 2 | 0 | 2 | 0 | 0 | 0 | 0 | 0 |
| 3 | 2 | 1 | 3 | 0 | 1 | 1 | 0 | 0 |
| 4 | 2 | 2 | 4 | 0 | 2 | 2 | 0 | 0 |
| 5 | 2 | 3 | 5 | 0 | 2 | 3 | 1 | 1 |
| 6 | 2 | 4 | 6 | 0 | 2 | 4 | 2 | 2 |
| 7 | 2 | 5 | 7 | 0 | 3 | 5 | 3 | 3 |
| 8 | 2 | 6 | 8 | 0 | 4 | 6 | 4 | 4 |
| 9 | 2 | 7 | 9 | 0 | 5 | 7 | 5 | 5 |
| 10 | 3 | 8 | 10 | 0 | 6 | 8 | 6 | 6 |
| 11 | 4 | 9 | 11 | 0 | 7 | 9 | 7 | 7 |
| 12 | 5 | 10 | 12 | 0 | 8 | 10 | 8 | 8 |
| 13 | 6 | 11 | 13 | 0 | 9 | 11 | 9 | 9 |
| 14 | 7 | 12 | 14 | 0 | 10 | 12 | 10 | 10 |
| 15 | 8 | 13 | 15 | 0 | 11 | 13 | 10 | 11 |
| 16 | 9 | 14 | 16 | 0 | 12 | 14 | 10 | 11 |
| 17 | 10 | 15 | 15 | 0 | 12 | 14 | 10 | 11 |
| 18 | 10 | 16 | 14 | 0 | 11 | 13 | 10 | 11 |
| 19 | 10 | 17 | 15 | 0 | 10 | 12 | 10 | 11 |
| 20 | 9 | 18 | 16 | 0 | 9 | 11 | 10 | 11 |

Such a table may be viewed as a task distance matrix. By constructing such task distance matrices, one may identify which tasks may be likely to be confused with others and at what stages of execution such confusion may be most probable. Specifically, if the edit distance between two different tasks remains low across multiple time indices, it may suggest that these tasks share similar action sequences, making them more prone to estimation errors. Additionally, analyzing the edit distance at a finer granularity, such as per action, may reveal which specific actions may be more frequently confused with others.

This information may also be valuable for improving task discrimination, refining action recognition models, and designing interventions to mitigate ambiguity, such as modifying the task execution process to include more distinctive actions or incorporating additional contextual cues for more accurate intention estimation.

One may experiment with the proposed method on a toy assembly work. The six tasks (Task 0-Task 5) with their nominal action sequences may be shown in FIGS. 2A-2F. There may be two nominal action sequences for Task 4 and Task 5, and may be indexed as 4(0), 4(1), 5(0) and 5(1). An action recognition module may be used for continuous-time action recognition. It may take vision and motion measurements as input and outputs recognized actions at 4 Hz sampling rate. Example task distance matrixes of the Task 0, 1, 2, 3, 4(0), 4(1), 5(0) and 5(1) to other tasks may be shown in the tables below.

Distance between Task 0 and other tasks

| Time | 0 | 1 | 2 | 3 | 4(0) | 4(1) | 5(0) | 5(1) |
|---|---|---|---|---|---|---|---|---|
| 1 | 0 | 1 | 1 | 1 | 1 | 1 | 1 | 1 |
| 2 | 0 | 2 | 2 | 2 | 2 | 2 | 2 | 2 |
| 3 | 0 | 3 | 3 | 2 | 3 | 3 | 2 | 2 |
| 4 | 0 | 4 | 4 | 2 | 4 | 4 | 2 | 2 |
| 5 | 0 | 5 | 5 | 2 | 5 | 5 | 3 | 3 |
| 6 | 0 | 6 | 6 | 2 | 6 | 6 | 4 | 4 |
| 7 | 0 | 7 | 7 | 2 | 7 | 7 | 5 | 5 |
| 8 | 0 | 8 | 8 | 2 | 8 | 8 | 6 | 6 |
| 9 | 0 | 9 | 9 | 2 | 9 | 9 | 7 | 7 |
| 10 | 0 | 10 | 10 | 3 | 10 | 10 | 8 | 8 |
| 11 | 0 | 11 | 11 | 4 | 11 | 11 | 9 | 9 |
| 12 | 0 | 12 | 12 | 5 | 12 | 12 | 10 | 10 |
| 13 | 0 | 13 | 13 | 6 | 13 | 13 | 11 | 11 |

Distance between Task 1 and other tasks

| Time | 0 | 1 | 2 | 3 | 4(0) | 4(1) | 5(0) | 5(1) |
|---|---|---|---|---|---|---|---|---|
| 1 | 1 | 0 | 1 | 0 | 0 | 0 | 0 | 0 |
| 2 | 2 | 0 | 2 | 0 | 0 | 0 | 0 | 0 |
| 3 | 3 | 0 | 3 | 1 | 1 | 1 | 1 | 1 |
| 4 | 4 | 0 | 4 | 2 | 2 | 2 | 2 | 2 |
| 5 | 5 | 0 | 5 | 3 | 3 | 3 | 3 | 3 |
| 6 | 6 | 0 | 6 | 4 | 4 | 4 | 4 | 4 |
| 7 | 7 | 0 | 6 | 5 | 5 | 5 | 5 | 5 |
| 8 | 8 | 0 | 6 | 6 | 6 | 6 | 6 | 6 |
| 9 | 9 | 0 | 7 | 7 | 7 | 7 | 7 | 7 |
| 10 | 10 | 0 | 8 | 8 | 8 | 8 | 8 | 8 |

Distance between Task 2 and other tasks

| Time | 0 | 1 | 2 | 3 | 4(0) | 4(1) | 5(0) | 5(1) |
|---|---|---|---|---|---|---|---|---|
| 1 | 1 | 1 | 0 | 1 | 1 | 1 | 1 | 1 |
| 2 | 2 | 2 | 0 | 2 | 2 | 2 | 2 | 2 |
| 3 | 3 | 3 | 0 | 3 | 3 | 3 | 3 | 3 |
| 4 | 4 | 4 | 0 | 4 | 4 | 4 | 4 | 4 |
| 5 | 5 | 5 | 0 | 5 | 5 | 5 | 5 | 5 |
| 6 | 6 | 6 | 0 | 6 | 6 | 6 | 6 | 6 |
| 7 | 7 | 6 | 0 | 7 | 7 | 7 | 7 | 7 |
| 8 | 8 | 6 | 0 | 8 | 8 | 8 | 8 | 8 |
| 9 | 9 | 7 | 0 | 9 | 9 | 9 | 9 | 9 |
| 10 | 10 | 8 | 0 | 10 | 10 | 10 | 10 | 10 |
| 11 | 11 | 8 | 0 | 11 | 11 | 11 | 11 | 11 |
| 12 | 12 | 8 | 0 | 12 | 12 | 11 | 12 | 12 |
| 13 | 13 | 8 | 0 | 13 | 13 | 12 | 13 | 12 |
| 14 | 13 | 8 | 0 | 14 | 14 | 13 | 14 | 12 |
| 15 | 12 | 9 | 0 | 15 | 14 | 13 | 15 | 13 |
| 16 | 11 | 10 | 0 | 16 | 14 | 13 | 16 | 14 |

Distance between Task 3 and other tasks

| Time | 0 | 1 | 2 | 3 | 4(0) | 4(1) | 5(0) | 5(1) |
|---|---|---|---|---|---|---|---|---|
| 1 | 1 | 0 | 1 | 0 | 0 | 0 | 0 | 0 |
| 2 | 2 | 0 | 2 | 0 | 0 | 0 | 0 | 0 |
| 3 | 2 | 1 | 3 | 0 | 1 | 1 | 0 | 0 |
| 4 | 2 | 2 | 4 | 0 | 2 | 2 | 0 | 0 |
| 5 | 2 | 3 | 5 | 0 | 2 | 3 | 1 | 1 |
| 6 | 2 | 4 | 6 | 0 | 2 | 4 | 2 | 2 |
| 7 | 2 | 5 | 7 | 0 | 3 | 5 | 3 | 3 |
| 8 | 2 | 6 | 8 | 0 | 4 | 6 | 4 | 4 |
| 9 | 2 | 7 | 9 | 0 | 5 | 7 | 5 | 5 |
| 10 | 3 | 8 | 10 | 0 | 6 | 8 | 6 | 6 |
| 11 | 4 | 9 | 11 | 0 | 7 | 9 | 7 | 7 |
| 12 | 5 | 10 | 12 | 0 | 8 | 10 | 8 | 8 |
| 13 | 6 | 11 | 13 | 0 | 9 | 11 | 9 | 9 |
| 14 | 7 | 12 | 14 | 0 | 10 | 12 | 10 | 10 |
| 15 | 8 | 13 | 15 | 0 | 11 | 13 | 10 | 11 |
| 16 | 9 | 14 | 16 | 0 | 12 | 14 | 10 | 11 |
| 17 | 10 | 15 | 15 | 0 | 12 | 14 | 10 | 11 |
| 18 | 10 | 16 | 14 | 0 | 11 | 13 | 10 | 11 |
| 19 | 10 | 17 | 15 | 0 | 10 | 12 | 10 | 11 |
| 20 | 9 | 18 | 16 | 0 | 9 | 11 | 10 | 11 |

Distance between Task 4(0) and other tasks

| Time | 0 | 1 | 2 | 3 | 4(0) | 4(1) | 5(0) | 5(1) |
|---|---|---|---|---|---|---|---|---|
| 1 | 1 | 0 | 1 | 0 | 0 | 0 | 0 | 0 |
| 2 | 2 | 0 | 2 | 0 | 0 | 0 | 0 | 0 |
| 3 | 3 | 1 | 3 | 1 | 0 | 0 | 1 | 1 |
| 4 | 4 | 2 | 4 | 2 | 0 | 0 | 2 | 2 |
| 5 | 4 | 3 | 5 | 2 | 0 | 1 | 3 | 3 |
| 6 | 4 | 4 | 6 | 2 | 0 | 2 | 4 | 4 |
| 7 | 5 | 5 | 7 | 3 | 0 | 3 | 4 | 4 |
| 8 | 6 | 6 | 8 | 4 | 0 | 4 | 4 | 4 |
| 9 | 7 | 7 | 9 | 5 | 0 | 4 | 4 | 4 |
| 10 | 8 | 8 | 10 | 6 | 0 | 4 | 4 | 4 |
| 11 | 9 | 9 | 11 | 7 | 0 | 4 | 4 | 4 |
| 12 | 10 | 10 | 12 | 8 | 0 | 4 | 4 | 4 |
| 13 | 11 | 11 | 13 | 9 | 0 | 4 | 4 | 5 |
| 14 | 11 | 12 | 14 | 10 | 0 | 4 | 4 | 6 |
| 15 | 11 | 13 | 14 | 11 | 0 | 4 | 5 | 7 |
| 16 | 10 | 14 | 14 | 12 | 0 | 4 | 6 | 8 |

Distance between Task 4(1) and other tasks

| Time | 0 | 1 | 2 | 3 | 4(0) | 4(1) | 5(0) | 5(1) |
|---|---|---|---|---|---|---|---|---|
| 1 | 1 | 0 | 1 | 0 | 0 | 0 | 0 | 0 |
| 2 | 2 | 0 | 2 | 0 | 0 | 0 | 0 | 0 |
| 3 | 3 | 1 | 3 | 1 | 0 | 0 | 1 | 1 |
| 4 | 4 | 2 | 4 | 2 | 0 | 0 | 2 | 2 |
| 5 | 5 | 3 | 5 | 3 | 1 | 0 | 3 | 2 |
| 6 | 6 | 4 | 6 | 4 | 2 | 0 | 4 | 2 |
| 7 | 7 | 5 | 7 | 5 | 3 | 0 | 5 | 2 |
| 8 | 8 | 6 | 8 | 6 | 4 | 0 | 6 | 3 |
| 9 | 9 | 7 | 9 | 7 | 4 | 0 | 6 | 4 |
| 10 | 10 | 8 | 10 | 8 | 4 | 0 | 6 | 4 |
| 11 | 11 | 9 | 11 | 9 | 4 | 0 | 6 | 4 |
| 12 | 12 | 10 | 11 | 10 | 4 | 0 | 6 | 4 |
| 13 | 13 | 11 | 12 | 11 | 4 | 0 | 7 | 5 |
| 14 | 12 | 12 | 13 | 12 | 4 | 0 | 8 | 6 |
| 15 | 11 | 13 | 13 | 13 | 4 | 0 | 9 | 7 |
| 16 | 10 | 14 | 13 | 14 | 4 | 0 | 10 | 8 |

Distance between Tusk 5(0) and other tasks

| Time | 0 | 1 | 2 | 3 | 4(0) | 4(1) | 5(0) | 5(1) |
|---|---|---|---|---|---|---|---|---|
| 1 | 1 | 0 | 1 | 0 | 0 | 0 | 0 | 0 |
| 2 | 2 | 0 | 2 | 0 | 0 | 0 | 0 | 0 |
| 3 | 2 | 1 | 3 | 0 | 1 | 1 | 0 | 0 |
| 4 | 2 | 2 | 4 | 0 | 2 | 2 | 0 | 0 |
| 5 | 3 | 3 | 5 | 1 | 3 | 3 | 0 | 1 |
| 6 | 4 | 4 | 6 | 2 | 4 | 4 | 0 | 2 |
| 7 | 5 | 5 | 7 | 3 | 4 | 5 | 0 | 3 |
| 8 | 6 | 6 | 8 | 4 | 4 | 6 | 0 | 4 |
| 9 | 7 | 7 | 9 | 5 | 4 | 6 | 0 | 5 |
| 10 | 8 | 8 | 10 | 6 | 4 | 6 | 0 | 6 |
| 11 | 9 | 9 | 11 | 7 | 4 | 6 | 0 | 6 |
| 12 | 10 | 10 | 12 | 8 | 4 | 6 | 0 | 6 |
| 13 | 11 | 11 | 13 | 9 | 4 | 7 | 0 | 7 |
| 14 | 11 | 12 | 14 | 10 | 4 | 8 | 0 | 8 |
| 15 | 11 | 13 | 15 | 10 | 5 | 9 | 0 | 8 |
| 16 | 12 | 14 | 16 | 10 | 6 | 10 | 0 | 8 |
| 17 | 13 | 15 | 16 | 10 | 6 | 10 | 0 | 8 |
| 18 | 14 | 16 | 16 | 10 | 6 | 10 | 0 | 8 |
| 19 | 14 | 17 | 15 | 10 | 6 | 9 | 0 | 8 |
| 20 | 14 | 18 | 16 | 10 | 6 | 8 | 0 | 8 |
| 21 | 13 | 19 | 17 | 9 | 5 | 7 | 0 | 8 |

Distance between Task 5(1) and other tasks

| Time | 0 | 1 | 2 | 3 | 4(0) | 4(1) | 5(0) | 5(1) |
|---|---|---|---|---|---|---|---|---|
| 1 | 1 | 0 | 1 | 0 | 0 | 0 | 0 | 0 |
| 2 | 2 | 0 | 2 | 0 | 0 | 0 | 0 | 0 |
| 3 | 2 | 1 | 3 | 0 | 1 | 1 | 0 | 0 |
| 4 | 2 | 2 | 4 | 0 | 2 | 2 | 0 | 0 |
| 5 | 3 | 3 | 5 | 1 | 3 | 2 | 1 | 0 |
| 6 | 4 | 4 | 6 | 2 | 4 | 2 | 2 | 0 |
| 7 | 5 | 5 | 7 | 3 | 4 | 2 | 3 | 0 |
| 8 | 6 | 6 | 8 | 4 | 4 | 3 | 4 | 0 |
| 9 | 7 | 7 | 9 | 5 | 4 | 4 | 5 | 0 |
| 10 | 8 | 8 | 10 | 6 | 4 | 4 | 6 | 0 |
| 11 | 9 | 9 | 11 | 7 | 4 | 4 | 6 | 0 |
| 12 | 10 | 10 | 12 | 8 | 4 | 4 | 6 | 0 |
| 13 | 11 | 11 | 12 | 9 | 5 | 5 | 7 | 0 |
| 14 | 12 | 12 | 12 | 10 | 6 | 6 | 8 | 0 |
| 15 | 13 | 13 | 13 | 11 | 7 | 7 | 8 | 0 |
| 16 | 14 | 14 | 14 | 11 | 8 | 8 | 8 | 0 |
| 17 | 15 | 15 | 14 | 11 | 9 | 9 | 8 | 0 |
| 18 | 16 | 16 | 14 | 11 | 10 | 8 | 8 | 0 |
| 19 | 15 | 17 | 13 | 11 | 10 | 7 | 8 | 0 |
| 20 | 14 | 18 | 14 | 11 | 10 | 6 | 8 | 0 |
| 21 | 13 | 19 | 15 | 10 | 9 | 5 | 8 | 0 |

One may also use a discrete-time action sequence extraction. Any action recognition error or deviation of the operator's action from the nominal action sequence may be converted to one of the insertion, deletion, or substitution edits after the discrete-time action sequence extraction.

One may compare the proposed method with two other methods. One of them may be a method that constructs a probabilistic graphical model to represent the joint distribution of the task and the corresponding action sequence, where model learning and inference may be implemented with probabilistic programming language (PPL); one may denote this method as the PPL method. The other method may be based on a transformer architecture which may be trained to estimate the task and predict the next action whenever a new action is observed; one may denote this method as the transformer method. Both methods may be trained solely on the nominal action sequences of the tasks, which is the amount of data for training as the proposed method. Both methods may achieve high intention estimation accuracy when running on seen tasks, and the PPL method in addition can provide highly accurate distribution or uncertainty estimations.

Seen tasks: One may first carry out experiments on real data collected when the operator completes the tasks appearing in the data which the action recognition module is trained on. This dataset may be the same as ones previously used where 194 trials of different tasks were collected. With the PPL method, the task estimation accuracy my saturate around 97% due to the edit errors in the extracted action sequence. With the proposed method, the task estimation accuracy achieves 100% at the middle of all the task executions, showing the effectiveness of the proposed method in tolerating edit errors.

Unseen tasks: More importantly, one may carry out real-time experiments where the operator completes the new tasks not appearing in the data which the action recognition module may be trained on. Among the 20 trials of different new tasks completed, half of them may be carried out by an experienced operator who strictly follows the nominal action sequences of each task, while the other half my be carried out by a novice operator who may try to follow the nominal action sequences as much as possible but may not be able to do so all the time. Using both the PPL method and the transformer method, in 8 out of the 20 trials the two methods may not be able to correctly estimate the task at the middle of the execution of the tasks. By contrast, the proposed edit distance based method may be able to correctly estimate the task at the middle of the executions for all trials. This may indicate the strong robustness of the proposed method to operator's variability and action recognition errors.

One limitation of testing only with real data is that it may not be easy to vary the amount of errors in the observed action sequence. To have a more thorough evaluation of the proposed method, one may generate observed action sequence in simulation with explicit control on the number of edits in each sequence. Specifically, for each nominal action sequence one may generate 1000 trials of it, while in each trial, one may perform a number of random edits at randomly picked locations, where each edit can be inserting a random action before the picked location, deleting the action at that location, or substitute the action at that location with a random action; and the number of edits ranges from 0 to 5.

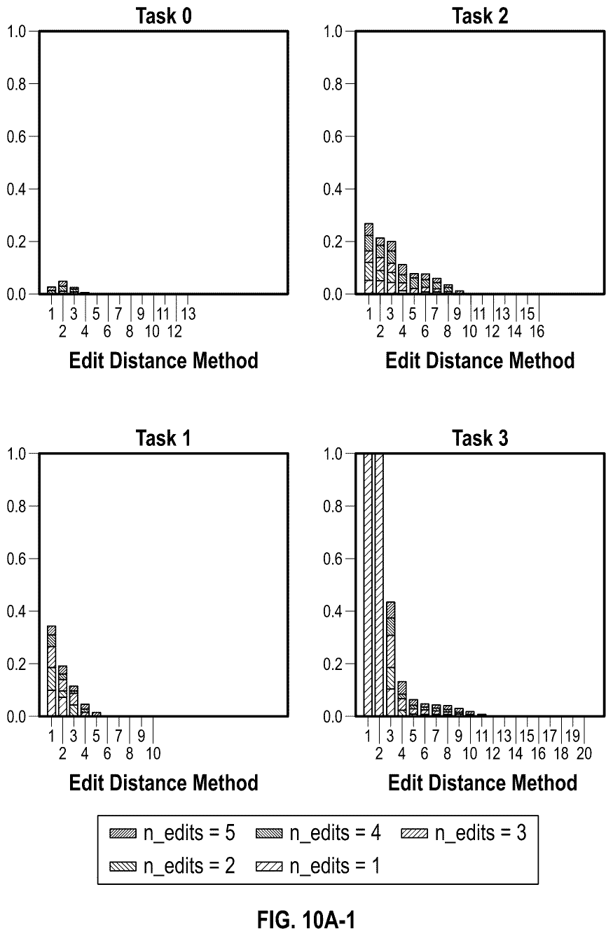

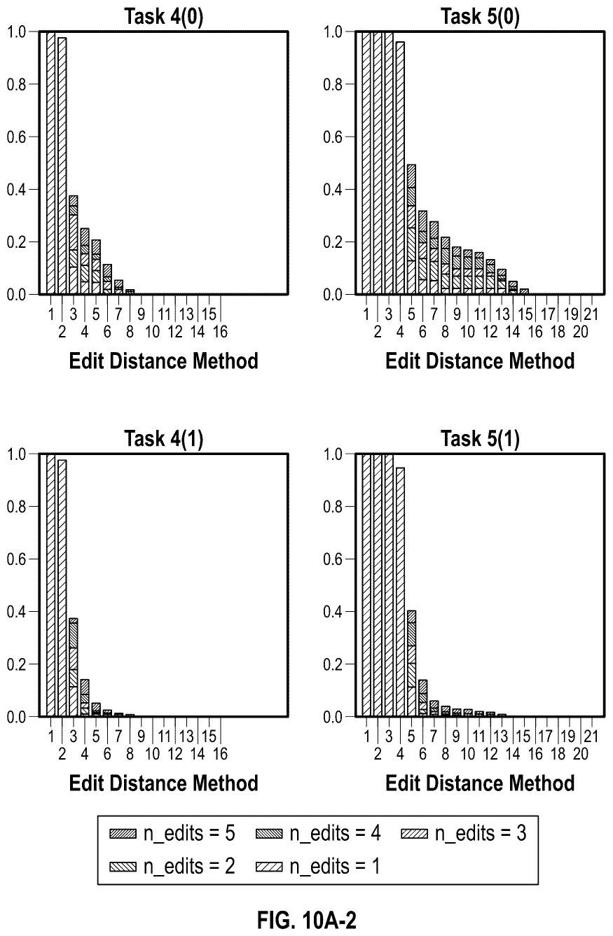

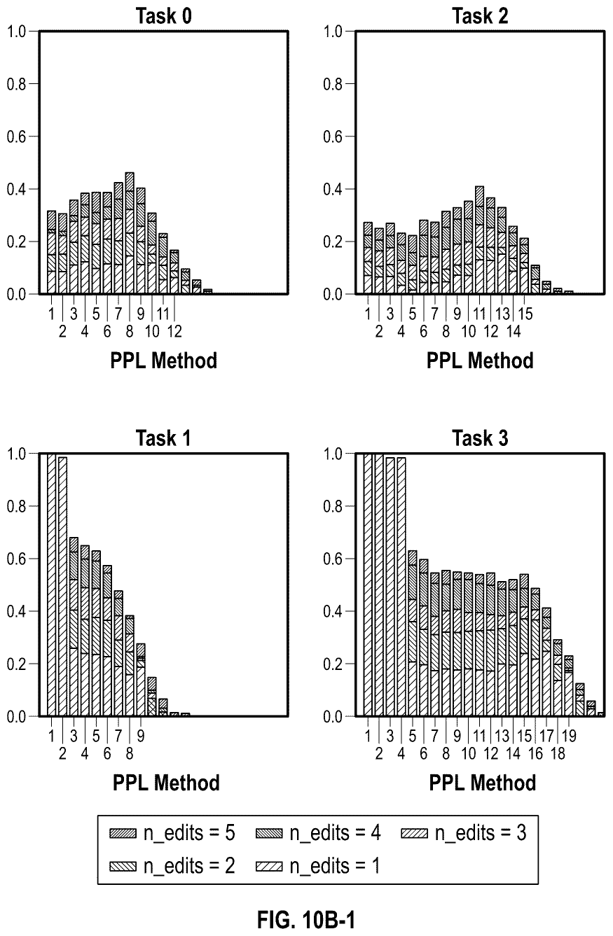

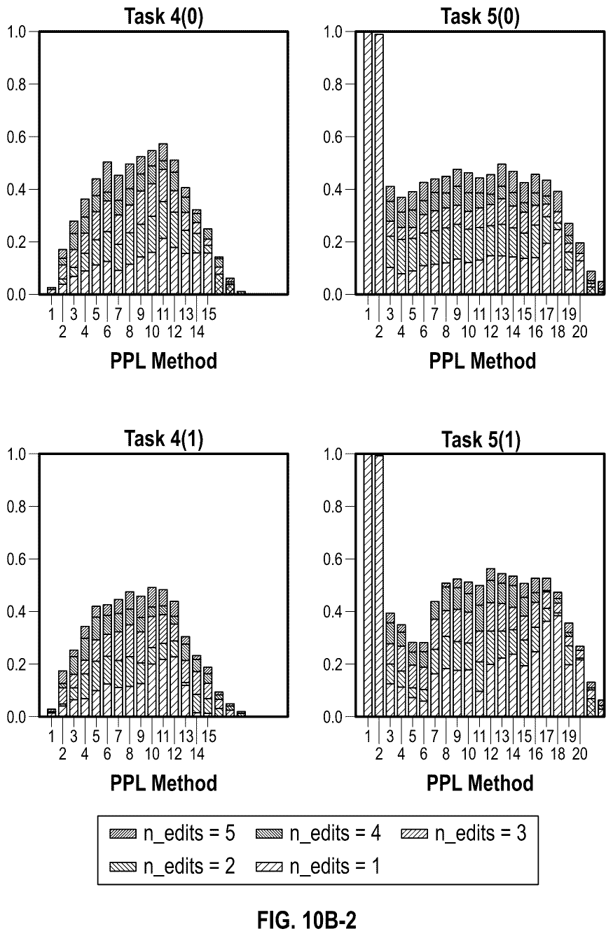

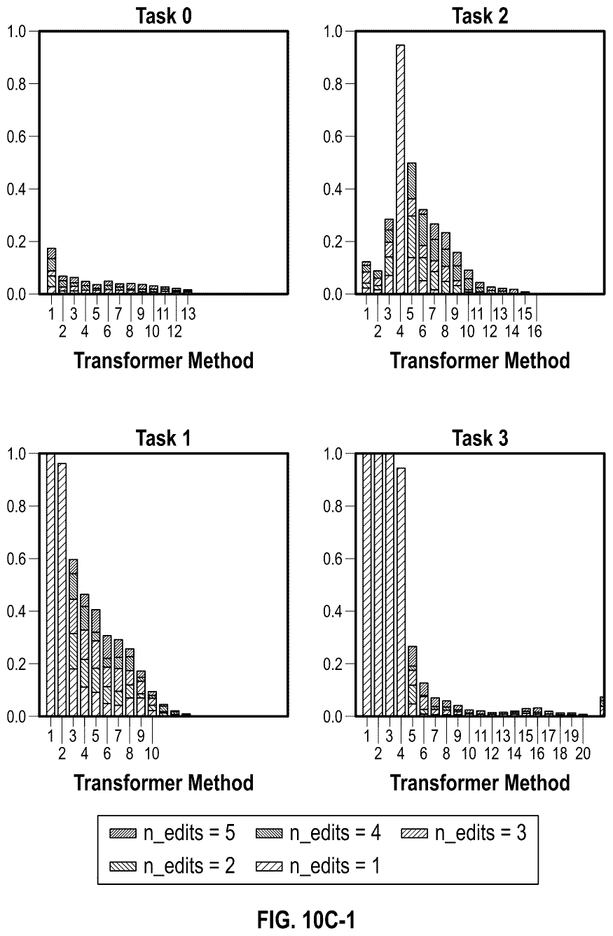

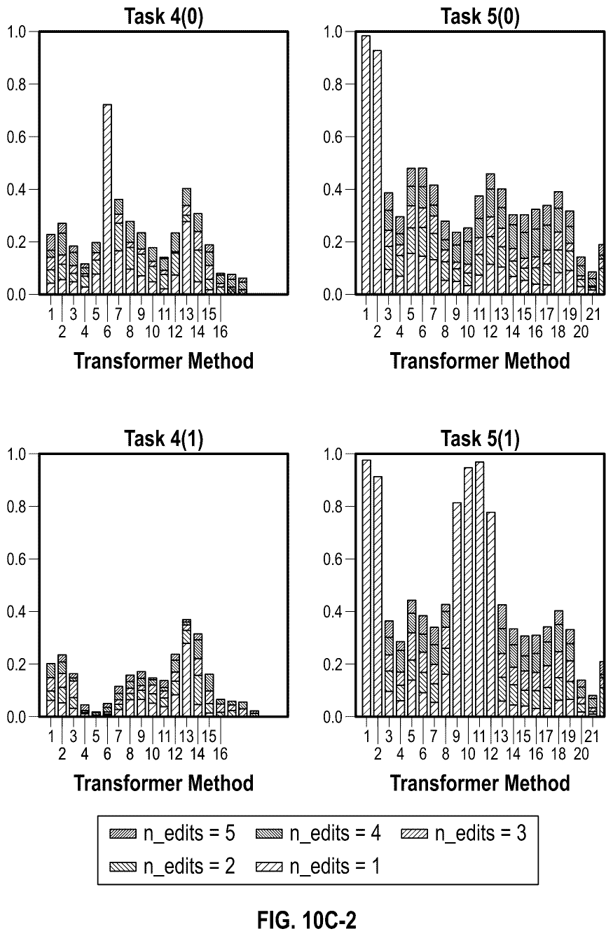

Task estimation: First one may examine the task estimation accuracy. FIG. 10A-1-10C-2 may show task estimation error rates of each task with different amount of errors in observed action sequence where the x-axis may be the time indices of actions, indicating the number of observed actions used in each estimation. FIGS. 6A-6C may show the average task estimation error rate without the presence of errors or edits in the observed action sequence, where the x-axis may be the action time indices, each of them may indicate the number of observed actions based on which the task estimation is performed. One may see that without the presence of action errors, the PPL method may achieve the lowest task estimation errors, while the edit distance based method may be only slightly worse. FIGS. 6A-6C may show how the ambiguities among the nominal action sequences among the tasks may lead to task estimation errors, and may also serve as a baseline for comparing the estimation accuracy in the presence of errors in the observed action sequence.

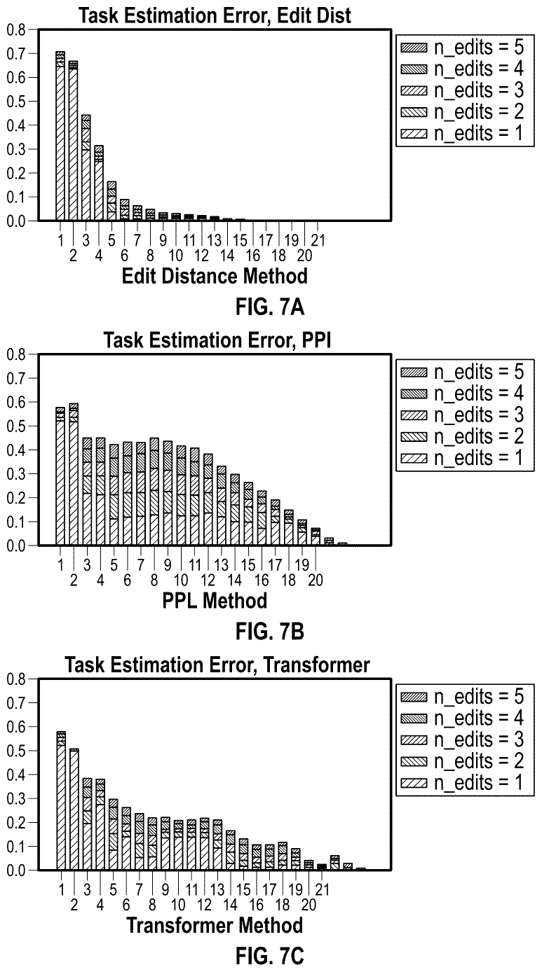

FIGS. 7A-7C may show the average task estimation error rate with different amount of errors in the observed action sequence, across different methods. One may clearly see that the proposed edit distance based method may achieve the lowest error rates whenever the number of observed actions is greater than 3, and the error rates may be lower than the other two methods.

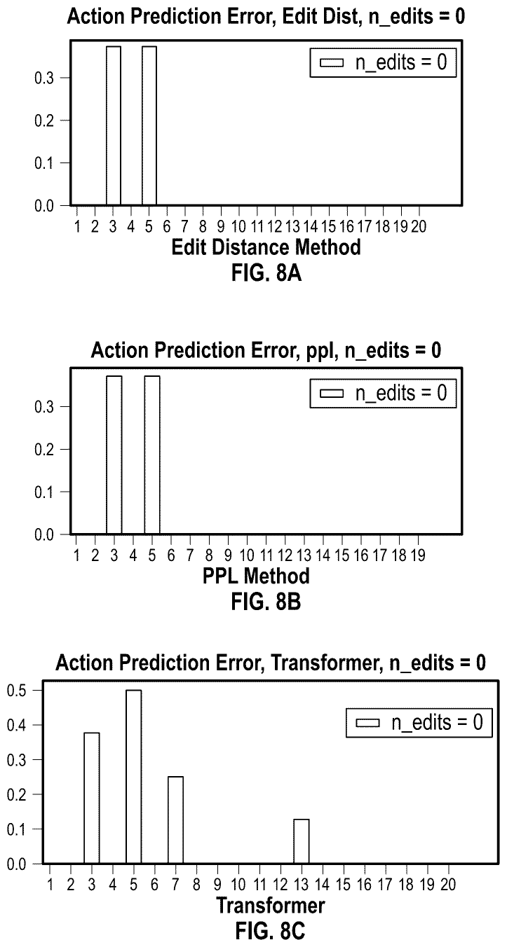

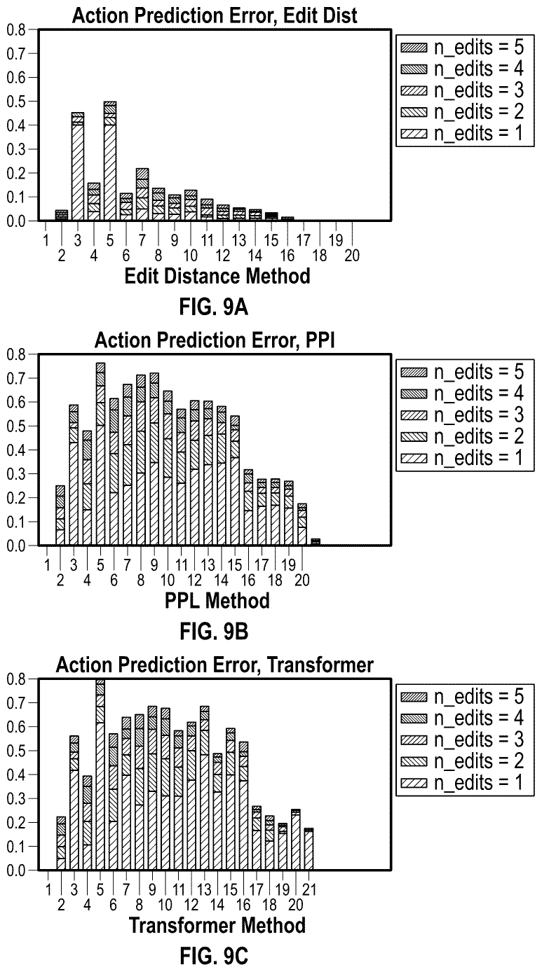

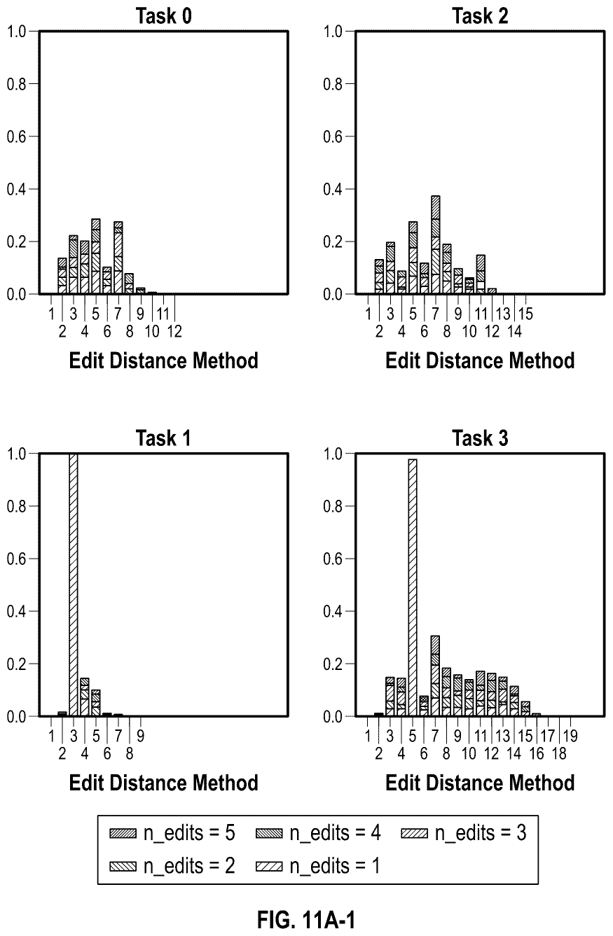

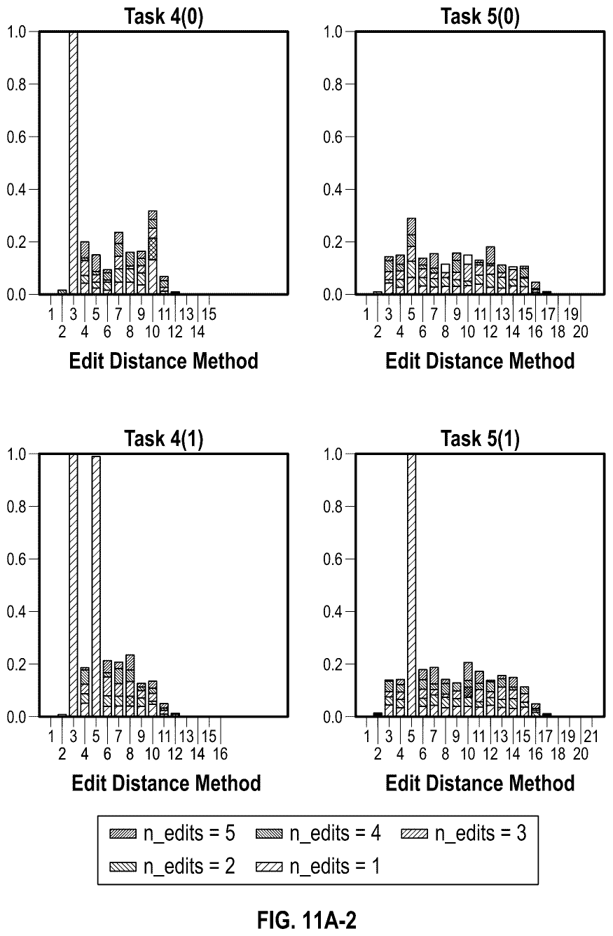

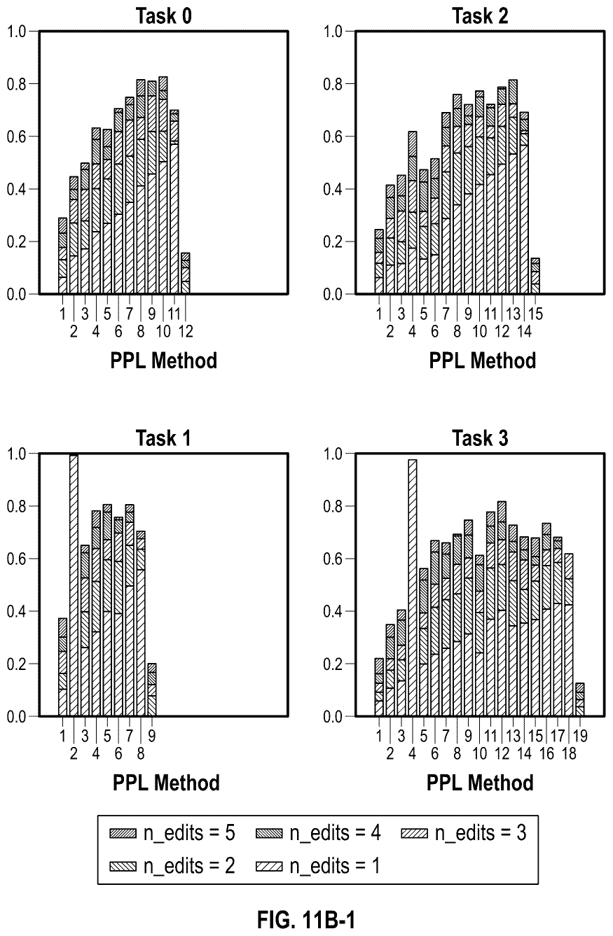

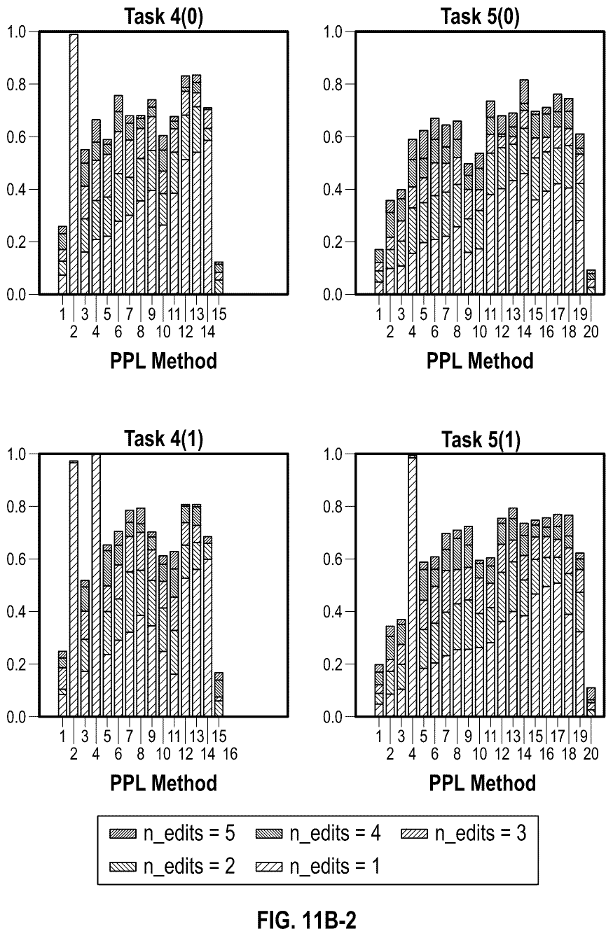

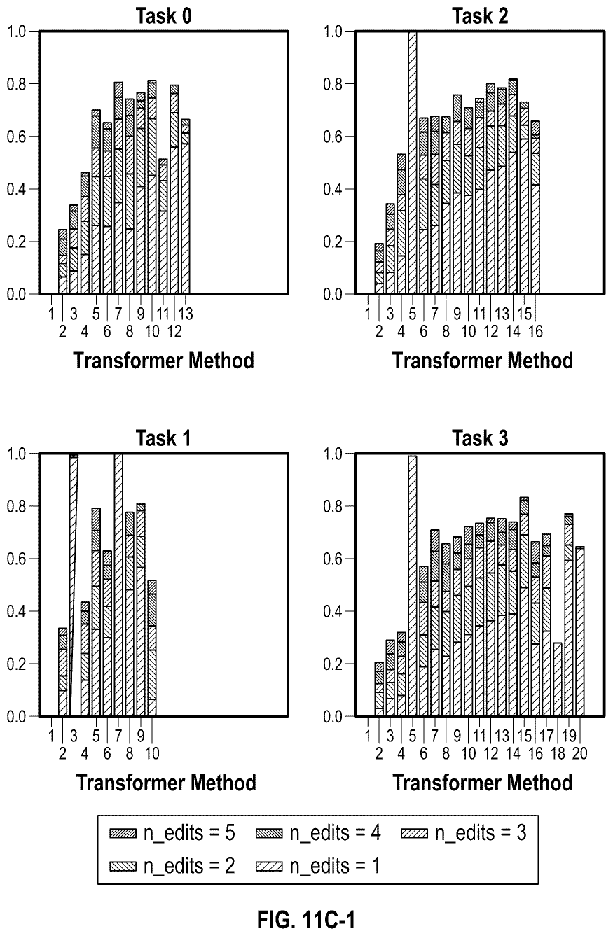

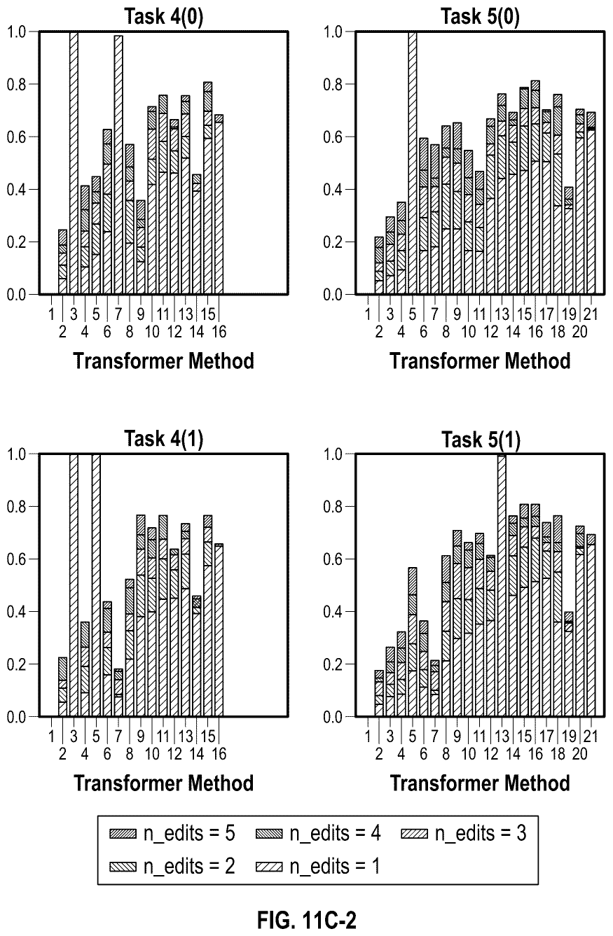

Next action prediction: One may then examine the next action prediction performance. FIGS. 11A-1-11C-2 may show action prediction error rates of each task with different amount of errors in observed action sequence, where the x-axis are the time indices of actions being predicted. Again, one may show the average action prediction error rates with and without action errors separately in FIGS. 8A-8C and FIGS. 9A-9C. FIGS. 8A-8C may show comparable accuracy for the proposed method and the PPL method, whereas FIGS. 9A-9C may show the significant robustness of the proposed method to the action errors compared with the other two methods.

As disclosed above, one may propose an edit distance-based approach for intention estimation in human-robot teleoperated assembly tasks. The proposed method quantifies the similarity between an observed action sequence and nominal action sequences using edit distance and employs the nearest neighbor rule for task estimation and action prediction. The key advantage of the proposed method may lie in its robustness to deviations in operator actions and action recognition errors, which may be common in real-world teleoperation settings.

Through extensive experiments with both real and simulated data, it may be demonstrated that the proposed method outperforms existing approaches, including probabilistic graphical models and transformer-based prediction methods, particularly in scenarios with significant action errors. The results indicate that the proposed method achieves higher accuracy in task estimation and action prediction, making it a promising solution for improving the reliability of teleoperated robotic systems. Additionally, one may construct task distance matrices to analyze task similarities and potential confusion points, offering insights into when and where estimation errors are likely to occur. This analysis can guide the design of more distinctive task sequences and improvements in action recognition models.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A method for intention estimation in robot teleoperation tasks comprising:
computing a correlation between an observed action sequence and nominal action sequences that define viable tasks sequentially using edit distance.

2. The method of claim 1, wherein using edit distance comprises using a nearest neighbor rule for task estimation and action prediction.

3. The method of claim 1, wherein using edit distance comprises computing a minimum number of operations to transform a current observed action sequence to any prefix of all nominal action sequences as a measure of how close the observed action sequence aligns with an expected action sequence.

4. The method of claim 3, wherein prefixes from all nominal action sequences having a smallest edit distance to a currently observed action sequence are used as an estimate of a current time index within a true action sequence and used to predict a next action by selecting a subsequent action in an estimated true action sequence.

5. The method of claim 1, wherein using edit distance comprises constructing a task distance matrix where each entry in the task distance matrix represents edit distances between elements of the observed action sequence and a current nominal action sequence to analyze task similarities and confusion points showing when and where estimation errors are to occur.

6. The method of claim 1, comprising:
defining a task distance matrix, where each entry in the task distance matrix corresponds to an edit distance between elements of the observed action sequence and elements of a current nominal action sequence of the nominal action sequences; and
computing the edit distances between the elements of the observed action sequence and the elements of the current nominal action sequence.

7. The method of claim 1, comprising:
defining a current task distance matrix, where each entry in the current task distance matrix corresponds to an edit distance between elements of the observed action sequence and elements of a current nominal action sequence of the nominal action sequences; and
computing the edit distances between the elements of the observed action sequence and the elements of the current nominal action sequence using an optimization process.

8. The method of claim 7, wherein the optimization process comprises using a previously computed edit distance stored in the current task distance matrix to compute a next edit distance.

9. The method of claim 7, comprising
defining successive task distance matrixes for the observed action sequence and all remining nominal action sequences where each entry in each successive task distance matrix corresponds to an edit distance between elements of the observed action sequence and elements of a corresponding nominal action sequence of the nominal action sequences; and
computing the edit distances between the elements of the observed action sequence and the elements of the corresponding nominal action sequence using the optimization process.

10. The method of claim 9, comprising
defining additional successive task distance matrixes for each additional observed action sequence and all nominal action sequences for a corresponding observed action sequence of the additional observed action sequences, where each entry in each additional successive task distance matrix corresponds to an edit distance between elements of the corresponding observed action sequence and elements of a corresponding nominal action sequence for the corresponding observed action sequence; and
computing the edit distances between the elements of the corresponding observed action sequence and elements of a corresponding nominal action sequence for the corresponding observed action sequence using the optimization process.

11. A method for intention estimation in robot teleoperation tasks comprising:
computing a correlation between an observed action sequence and nominal action sequences that define viable tasks sequentially using edit distance which uses a nearest neighbor rule for task estimation and action prediction;
constructing a task distance matrix where each entry in the task distance matrix represents edit distances between elements of the observed action sequence and a current nominal action sequence of the nominal action sequences to analyze task similarities and confusion points showing when and where estimation errors are to occur.

12. The method of claim 11, comprising computing the edit distances between the elements of the observed action sequence and the elements of the current nominal action sequence.

13. The method of claim 11, comprising computing the edit distances between the elements of the observed action sequence and the elements of the current nominal action sequence using an optimization process that uses a previously computed edit distance stored in the task distance matrix to compute a next edit distance.

14. The method of claim 11, comprising:
defining successive task distance matrixes for the observed action sequence and all remining nominal action sequences where each entry in each successive task distance matrix corresponds to an edit distance between elements of the observed action sequence and elements of a corresponding nominal action sequence of the nominal action sequences; and
computing the edit distances between the elements of the observed action sequence and the elements of the corresponding nominal action sequence using the optimization process.

15. The method of claim 14, comprising:
defining additional successive task distance matrixes for each additional observed action sequence and all nominal action sequences for a corresponding additional observed action sequence, where each entry in each additional successive task distance matrix corresponds to an edit distance between elements of the corresponding additional observed action sequence and elements of a corresponding nominal action sequence for the corresponding additional observed action sequence; and
computing the edit distances between the elements of the corresponding additional observed action sequence and elements of the corresponding nominal action sequence for the corresponding additional observed action sequence using the optimization process.

16. A method for intention estimation in robot teleoperation tasks comprising:
computing a correlation between observed action sequences and nominal action sequences that define viable tasks sequentially using edit distance comprising:
constructing a first task distance matrix where each entry in the first task distance matrix represents edit distances between elements of a first observed action sequence and a first nominal action sequence to analyze task similarities and confusion points showing when and where estimation errors are to occur; and
computing the edit distances between the elements of the first observed action sequence and the elements of the first nominal action sequence using an optimization process.

17. The method of claim 16, wherein the optimization process comprises using a previously computed edit distance stored in the first task distance matrix to compute a next edit distance.

18. The method of claim 16, comprising
defining successive task distance matrixes for the first observed action sequence and all remining nominal action sequences corresponding with the first observed action sequence where each entry in each successive task distance matrix corresponds to an edit distance between elements of the first observed action sequence and elements of a corresponding nominal action sequence of the remining nominal action sequences corresponding with the first observed action sequence; and
computing the edit distances between the elements of the first observed action sequence and elements of a corresponding nominal action sequence of the remining nominal action sequences corresponding with the first observed action sequence.

19. The method of claim 18, comprising
defining additional successive task distance matrixes for each additional observed action sequence and all nominal action sequences for a corresponding observed action sequence of the additional observed action sequences, where each entry in each additional successive task distance matrix corresponds to an edit distance between elements of the corresponding observed action sequence and elements of a corresponding nominal action sequence for the corresponding observed action sequence; and
computing the edit distances between the elements of the corresponding observed action sequence and elements of a corresponding nominal action sequence for the corresponding observed action sequence.

20. The method of claim 16, wherein a smallest edit distance between the elements of the first observed action sequence and the elements of the first nominal action sequence provides an estimate of a corresponding robot teleoperation tasks being executed.
